(19) United States
(12) Patent Application Publication
(10) Pub. No.: US 2012/0252270 A1
(43) Pub. Date: Oct. 4, 2012

(54) USB Connector

(76) Inventors: Gang Lee, Shanghai (CN); Huibin Li, Shanghai (CN); Wei Yao, Shanghai (CN)

(21) Appl. No.: 13/431,292

(22) Filed: Mar. 27, 2012

(30) Foreign Application Priority Data
Mar. 28, 2011 (CN) 201110083935.7

(51) Int. Cl. H01R 13/648

(52) U.S. Cl. 439/607.01

(57) ABSTRACT

A USB connector is provided that delivers a large amount of power to a connecting electronic apparatus. The USB connector includes an insulation body, a metal shield, a power contact, and an assistant contact. The metal shield cover the insulation body, and the power contact and the assistant power contact are mounted on the insulation body. Additionally, the power contact and the assistant power contact are configured to be electrically in contact simultaneously with a mating power contact of a mating USB connector.

### CROSS-REFERENCE TO RELATED APPLICATION

This application claims priority under 35 U.S.C. §119 to Chinese Patent Application No. 201110083935.7, filed on Mar. 28, 2011.

### FIELD OF INVENTION

The present invention relates to a Universal Serial Bus (USB) connector and, more particularly, to a USB connector for use with a large-power electronic apparatus.

### BACKGROUND

A known USB connector generally includes a common power contact, a ground contact, and a plurality of differential signal contacts. The common power contact is used to supply electric power to the USB connector and an electrical apparatus connected to the USB connector.

With the power of the electrical apparatus becoming higher and higher, the common power contact of the known USB connector needs to carry a higher current than before. However, the common power contact of the traditional USB connector must accord to a design standard and its size cannot be modified according to various practical applications. Therefore, the common power contact of the traditional USB connector cannot be used to carry a current above an upper limit value and cannot be adapted for an electrical apparatus with a power higher than a power limit.

Accordingly, the known USB connector can only be used to connect with an electrical apparatus with a power below the power limit, and its application is greatly limited.

### SUMMARY

The invention has been made to overcome or alleviate at least one aspect of the above mentioned disadvantages, among others. Accordingly, it would be desirable to provide a USB connector which is well adapted to an electrical apparatus with a power higher than before.

The USB connector includes an insulation body, a metal shield, a power contact, and an assistant contact. The metal shield cover the insulation body, and the power contact and the assistant power contact are mounted on the insulation body. Additionally, the power contact and the assistant power contact are configured to be electrically in contact simultaneously with a mating power contact of a mating USB connector.

### BRIEF DESCRIPTION OF THE DRAWINGS

The above and other features of the present invention will become more apparent by describing in detail exemplary embodiments thereof with reference to the accompanying drawings, in which:

FIG. 1 is an exploded view of a USB connector according to the invention;

FIG. 2 is a rear perspective view of an assembled USB connector according to the invention;

FIG. 3 is a bottom perspective view of the assembled USB connector shown in FIG. 2;

FIG. 4 is an enlarged view of a power contact and an assistant power contact of the USB connector shown in FIG. 1;

FIG. 5 is a side view showing a plug (that is, a mating USB connector) of a high-power electrical apparatus inserted into the USB connector shown in FIGS. 1-3; and

FIG. 6 is a side view showing connection between a plurality of contacts of the mating USB connector and a plurality of contacts of the USB connector after the mating USB connector is inserted into the USB connector according to the invention.

### DETAILED DESCRIPTION OF THE EMBODIMENT(S)

Exemplary embodiments of the invention will be described hereinafter in detail with reference to the attached drawings, wherein the like reference numerals refer to the like elements. The present invention may, however, be embodied in many different forms and should not be construed as being limited to the embodiment set forth herein; rather, these embodiments are provided so that the disclosure of the invention will be thorough and complete, and will fully convey the concept of the invention to those skilled in the art.

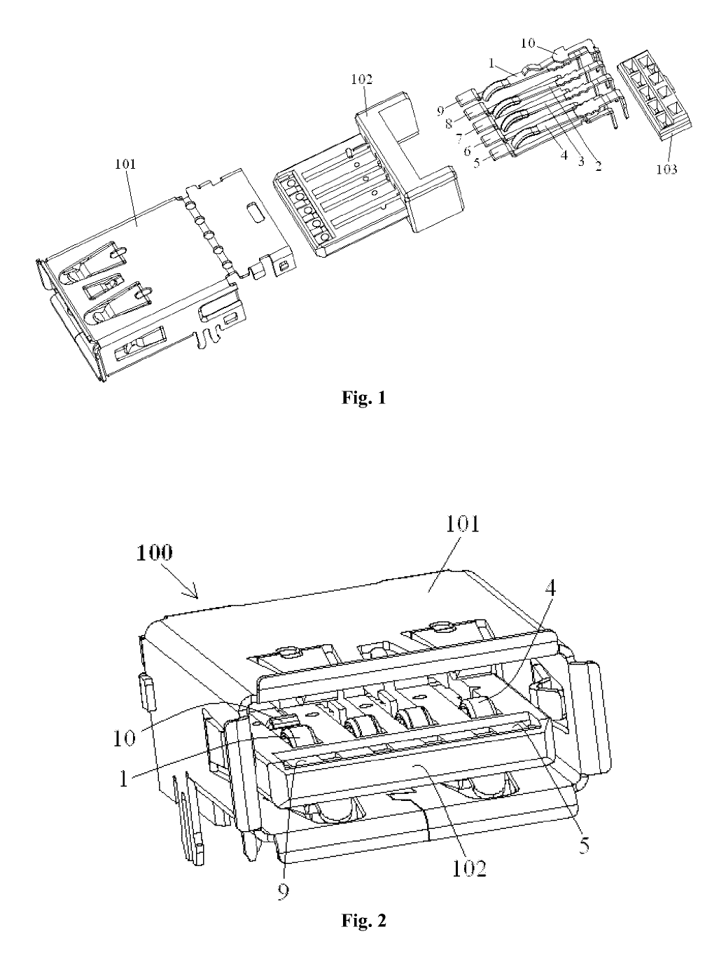

As shown in FIGS. 1-3, a USB connector 100, for example, a USB 3.0 connector, is shown, as an exemplary embodiment of the invention. However, the invention is not limited to this. The USB connector 100 may be another type of USB connector, for example, a USB 2.0 connector, and the like. Additionally, the USB connector 100 may be a female type connector.

With reference to FIGS. 1-3, the USB connector 100 may be a female USB 3.0 connector which includes a metal shield 101, an insulation body 102, a plurality of contacts 1, 2, 3, 4, 5, 6, 7, 8, 9, 10 mounted on the insulation body 102, and a rear insulation holder 103.

In the shown embodiment of FIGS. 1-3, the USB connector 100 accords to traditional USB 3.0 design standard, except that an additional assistant power contact 10 is provided. Because the traditional USB 3.0 design standard is well-known to those skilled in this art, for the purpose of conciseness, its detailed description is omitted herein.

As shown in FIG. 1, the plurality of contacts includes a common power contact 1, a pair of contacts 2, 3 that are low-speed differential signal contacts, which may be compatible with a USB 2.0 connector, two pairs of high-speed differential signal contacts 5, 6, 8, 9, a ground contact 4 for the USB 2.0 connector, a ground contact 7 for the USB 3.0 connector, and a assistant power contact 10.

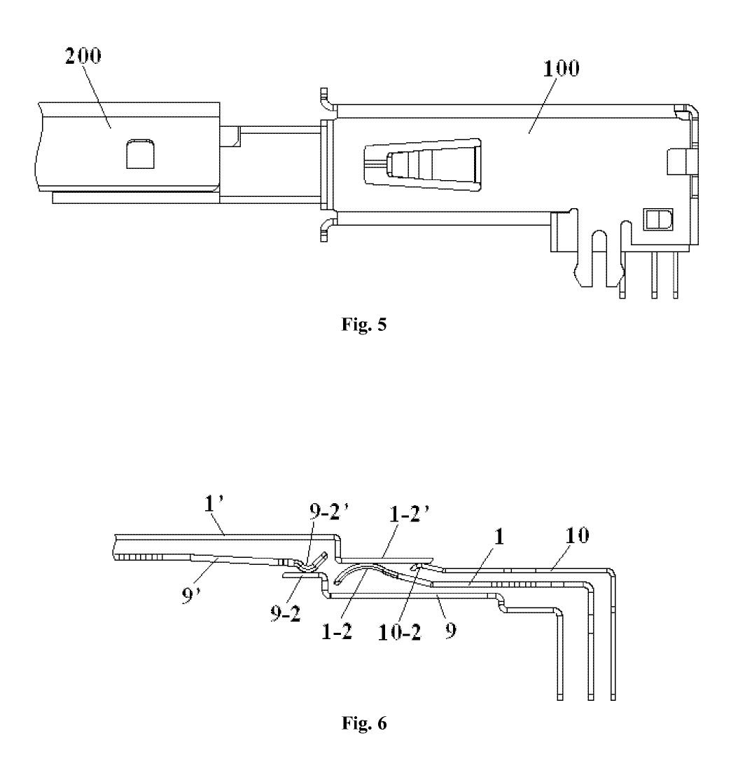

As shown in FIGS. 1-3, the assistant power contact 10 is disposed adjacent to the power contact 1, and the assistant power contact 10 and the power contact 1 together supply electric power to an external electrical apparatus (such as a plug 200 for the external electrical apparatus, as shown in FIGS. 5-6, a mating USB connector). In fact, in the shown embodiment, the assistant power contact 10 may be located above the power contact 1.

With reference to FIGS. 1 and 6, a contact portion 1-2 of the power contact 1 is shown, which is electrically connected with a mating power contact 1′ of the mating USB connector 200. As shown in FIGS. 4 and 6, the contact portion 1-2 of the power contact 1 is positioned in front of a contact portion 10-2 of the assistant power contact 10 being electrically connected with the mating power contact 1′ of the mating USB connector 200.

The contact portion 1-2 of the power contact 1 and the contact portion 10-2 of the assistant power contact 1 include major surfaces that lie parallel in the same horizontal plane. Moreover, a contact portion 1-2′ of the mating power contact 1′ may have a horizontal bottom surface for being simultaneously in electrical contact with the contact portion 1-2 of the power contact 1 and the contact portion 10-2 of the assistant power contact 10 include major surfaces that lie parallel in the same horizontal plane. In this way, the power contact 1 and the assistant power contact 10 of the USB connector 100 may be kept simultaneously and electrically in contact with the mating power contact l′ of the mating USB connector 200.

As shown in FIGS. 1 and 2, all contacts 1, 2, 3, 4, 5, 6, 7, 8, 9, 10 of the USB contact 100 are assembled in an insulation body 102 and electrically isolated from each other.

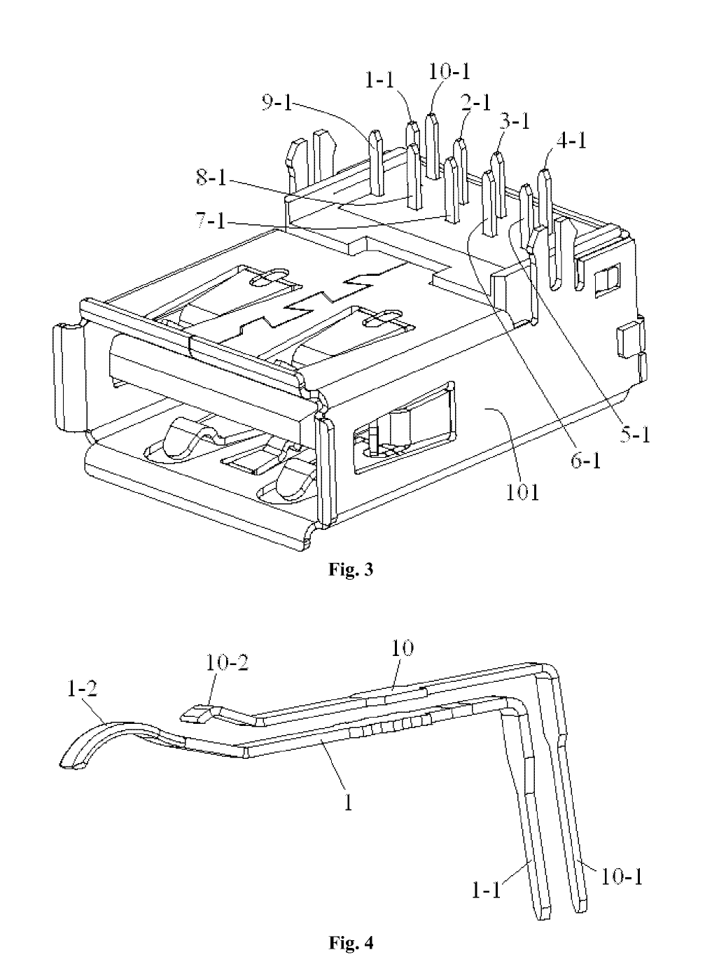

As shown in FIGS. 1 and 3, the contacts 1, 2, 3, 4, 5, 6, 7, 8, 9, 10 have pins 1-1, 2-1, 3-1, 4-1, 5-1, 6-1, 7-1, 8-1, 9-1, 10-1 at a rear end thereof, respectively. All these pins 1-1, 2-1, 3-1, 4-1, 5-1, 6-1, 7-1, 8-1, 9-1, 10-1 are secured and positioned in slots of the insulation holder 103.

Further, as shown in FIGS. 2 and 3, the insulation body 102 and the insulation holder 103 are enclosed in the metal shield 101.

As shown in FIG. 4, a body of the assistant power contact 10 is located slightly above the power contact 1, and is spaced from the power contact 1. However, as discussed above, the contact portion 1-2 of the power contact 1 and the contact portion 10-2 of the assistant power contact 1 include major surfaces that lie parallel in the same horizontal plane.

Accordingly, a front end of the power contact 1 is curved to form a spring contact portion 1-2 for being electrically in contact with the mating power contact 1′, and the rear end of the power contact 1 forms a pin 1-1 for electrically connecting to a PCB (not shown). Similarly, a front end of the assistant power contact 10 is curved to form a spring contact portion 10-2 for being in electrical contact with the mating power contact 1′, and the rear end of the power contact 10 forms a pin 10-1 for electrically connecting to the PCB.

Although it is not shown, other contacts all have a similar structure as the contacts 1 and 10, for example, the contact 9 has a contact portion 9-2 (referring to FIG. 6) at a front end thereof and a pin 9-1 (referring to FIG. 3) at a rear end thereof.

With reference to FIGS. 5 and 6, when the plug of the external electrical apparatus (that is, the mating USB connector 200) of a high-power electrical apparatus is inserted into the USB connector 100 shown in FIGS. 1-3, the mating power contact 1′ of the mating USB connector 200 of the high-power electrical apparatus is brought into electrical contact with the power contact 1 and the assistant power contact 10 of the USB connector 100. Accordingly, the current carrying capacity of the USB connector 100 is improved, and the USB connector 100 of the invention can carry higher current to the external electronic apparatus than before.

For mating with the USB connector 100 shown in FIGS. 1-3, the mating USB connector 200 includes ground contacts and signal contacts, respectively, corresponding to the ground contacts and the signal contacts of the USB connector 100. For example, as shown in FIG. 6, the mating USB connector 200 has a high-speed differential signal contact 9′ for being electrically in contact with the high-speed differential signal contact 9 of the USB connector 100.

Although it is not shown, when the mating USB connector 200 is inserted into the USB connector 100, the contact portions of the ground contacts and signal contacts of the mating USB connector 200 are electrically connected with contact portions of the ground contacts and signal contacts of the USB connector 100, respectively.

Although an embodiment has been shown and described, it should be appreciated by those skilled in the art that various changes or modifications may be made without departing from the principles and spirit of the invention, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A USB connector, comprising:
an insulation body;
a metal shield covering the insulation body; and
a power contact and an assistant power contact mounted on the insulation body and configured to be electrically in contact simultaneously with a mating power contact of a mating USB connector.

2. The USB connector according to claim 1, wherein the power contact and the assistant power contact are positioned adjacent to each other.

3. The USB connector according to claim 2, wherein a contact portion of the power contact and a contact portion of the assistant power contact include major contact surfaces that lie parallel in a horizontal plane.

4. The USB connector according to claim 3, wherein the USB connector is a female connector and the mating USB connector is a male connector.

5. The USB connector according to claim 3, further comprising a ground contact and a signal contact.

6. The USB connector according to claim 5, wherein the ground contact, the signal contact, the power contact, and the assistant power contact are electrically isolated from each other when positioned in the insulation body.

7. The USB connector according to claim 5, wherein the ground contact, the signal contact, the power contact, and the assistant power contact each include a pin disposed at a first end thereof.

8. The USB connector according to claim 7, wherein the ground contact, the signal contact, the power contact, and the assistant power contact each include a contact portion at a second end thereof.

9. The USB connector according to claim 8, further comprising an insulation holder in which the pins of the contacts of the USB contact are positioned.

10. The USB connector according to claim 9, wherein the metal shield covers the insulation body and the insulation holder therein.

11. The USB connector according to claim 10, wherein the mating USB connector further comprises a ground contact and a signal contact that corresponds to the ground contact and the signal contact of the USB connector.

12. The USB connector according to claim 11, wherein contact portions of the ground contacts and the signal contacts of the mating USB connector are electrically connected with the contact portions of the ground contact and the signal contact of the USB connector when the mating USB connector is inserted into the USB connector.
